(19) United States
(12) Patent Application Publication
(10) Pub. No.: US 2007/0279780 A1
(43) Pub. Date: Dec. 6, 2007

(54) METHOD AND APPARATUS TO OPTIMIZE WRITE CURRENT IN A WRITE HEAD

(76) Inventor: Craig Tomita, Pleasanton, CA (US)

Correspondence Address: SCHWEGMAN, LUNDBERG & WOESSNER, P.A., P.O. BOX 2938, MINNEAPOLIS, MN, 55402, US

(21) Appl. No.: 11/421,432

(22) Filed: May 31, 2006

(51) Int. Cl. G11B 27/36; G11B 21/02

(52) U.S. Cl. 360/31; 360/75

(57) ABSTRACT

A method for selecting a write current for a disk drive including writing a test track on a magnetic media at one of a plurality of write current levels, and writing signals to the magnetic media at positions adjacent to the test track at substantially the same write current level as used on the test track. The method also includes reading the signals from the magnetic media at positions adjacent to the test track, and monitoring a parameter associated with the signals read from the adjacent test track, and selecting one of the write current levels based on the monitored parameter.

### BACKGROUND

A disk drive is an information storage device. A disk drive includes one or more disks clamped to a rotating spindle, and at least one head for reading information representing data from and/or writing data to the surfaces of each disk. More specifically, storing data includes writing information representing data to portions of tracks on a disk so that it can be subsequently read and retrieved. Disk drives associated with a computing system generally execute write commands from a host computer. By the time a write command from a host computer passes through a read/write channel of the disk drive, the write command includes specific information including the location on the disk where the specific information will be written.

The disks include a magnetic layer or several magnetic layers formed on a non-magnetic disk substrate made of glass, aluminum or the like. The magnetic layer is magnetized by a transducing head. In some disk drives, the transducing head has a write head for writing information representing data to the disk and a separate read head for reading information from the disk. Writing information to the disk includes magnetizing the magnetic layer of the disk using the write element of the transducer. Various write current levels can be selected. Generally, the write current level is selected so that it is over a level that saturates the magnetic media. The write current level is also selected that will not cause problems in a read head or read element such as a magneto resistive head. The selected write current is between these two levels.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures and:

FIG. 1 is an exploded view of a disk drive that uses example embodiments described herein.

FIG. 2 is a schematic diagram of a disk drive and includes various electrical portions of the disk drive, according to an example embodiment.

FIG. 3 is a schematic diagram showing portions of the read/write path of FIG. 2, according to an example embodiment.

FIG. 4 is a flow diagram of a method for selecting a write current for a magnetic medium in a disk drive, according to an example embodiment.

FIG. 5A is a first portion of a flow diagram of a method for selecting a write current for a magnetic medium, according to an example embodiment.

FIG. 5B is a second portion of a flow diagram of a method for selecting a write current for a magnetic medium, according to an example embodiment.

FIG. 6 is a graph for selecting an optimum write current level for a magnetic medium in a disk drive, according to an example embodiment.

FIG. 7 is a flow diagram of a method for selecting an optimum write current level for a magnetic medium in a disk drive, according to an example embodiment.

FIG. 8 is a representation of a computing system, according to an example embodiment.

FIG. 9 is schematic of a machine-readable media, according to an example embodiment.

The description set out herein illustrates the various embodiments of the invention and such description is not intended to be construed as limiting in any manner.

### DETAILED DESCRIPTION

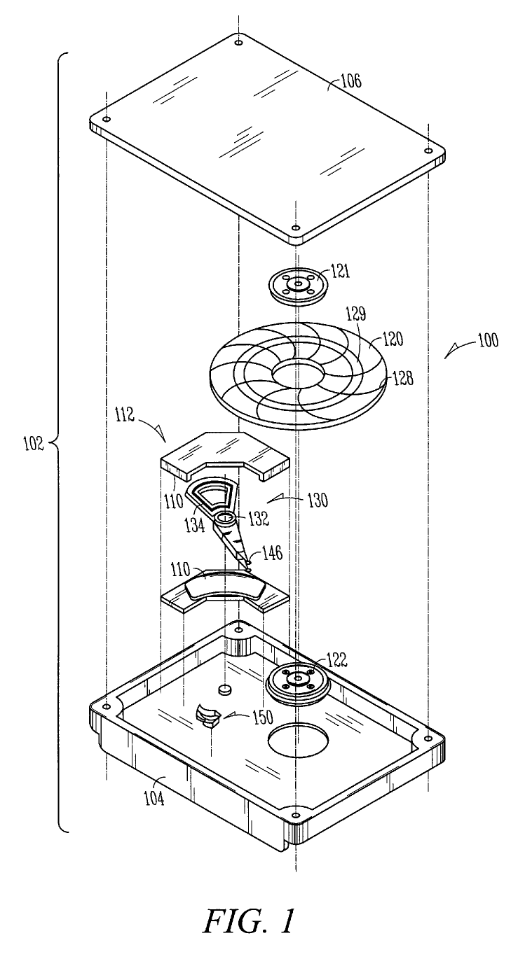

FIG. 1 is an exploded view of disk drive 100 that uses various embodiments of the present invention. The disk drive 100 includes a housing 102 including a housing base 104 and a housing cover 106. The housing base 104 illustrated is a base casting, but in other embodiments a housing base 104 can comprise separate components assembled prior to, or during assembly of the disk drive 100. A disk 120 is attached to a hub or spindle 122 that is rotated by a spindle motor. The disk 120 can be attached to the hub or spindle 122 by a clamp 121. The disk may be rotated at a constant or varying rate ranging from less than 3,600 to more than 15,000 revolutions per minute. Higher rotational speeds are contemplated in the future. The spindle motor is connected with the housing base 104. The disk 120 can be made of a light aluminum alloy, ceramic/glass or other suitable substrate, with magnetizable material deposited on one or both sides of the disk. The magnetic layer includes small domains of magnetization for storing data transferred through a transducing head 146. The transducing head 146 includes a magnetic transducer adapted to read data from and write data to the disk 120. In other embodiments, the transducing head 146 includes a separate read element and write element. For example, the separate read element can be a magneto-resistive head, also known as a MR head. It will be understood that multiple head 146 configurations can be used.

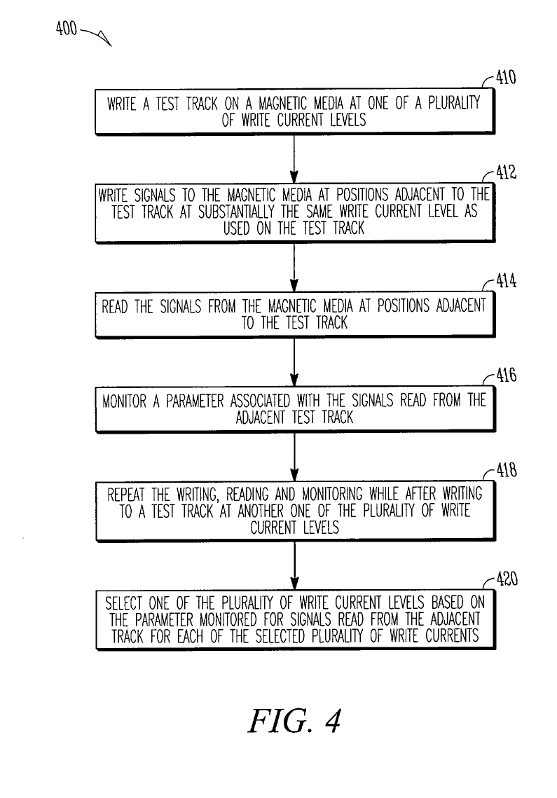

A rotary actuator 130 is pivotally mounted to the housing base 104 by a bearing 132 and sweeps an arc between an inner diameter (ID) of the disk 120 and a ramp 150 positioned near an outer diameter (OD) of the disk 120. Attached to the housing 104 are upper and lower magnet return plates 110 and at least one magnet that together form the stationary portion of a voice coil motor (VCM) 112. A voice coil 134 is mounted to the rotary actuator 130 and positioned in an air gap of the VCM 112. The rotary actuator 130 pivots about the bearing 132 when current is passed through the voice coil 134 and pivots in an opposite direction when the current is reversed, allowing for control of the position of the actuator 130 and the attached transducing head 146 with respect to the disk 120. The VCM 112 is coupled with a servo system (shown in FIG. 4) that uses positioning data read by the transducing head 146 from the disk 120 to determine the position of the head 146 over one of a plurality of tracks on the disk 120. The servo system determines an appropriate current to drive through the voice coil 134, and drives the current through the voice coil 134 using a current driver and associated circuitry (not shown in FIG. 1).

Each side of a disk 120 can have an associated head 146, and the heads 146 are collectively coupled to the rotary actuator 130 such that the heads 146 pivot in unison. The invention described herein is equally applicable to devices wherein the individual heads separately move some small distance relative to the actuator. This technology is referred to as dual-stage actuation (DSA).

One type of servo system is an embedded, servo system in which tracks on each disk surface used to store information representing data contain small segments of servo information. The servo information, in some embodiments, is stored in radial servo sectors or servo wedges 128 shown as several narrow, somewhat curved spokes substantially equally spaced around the circumference of the disk 120. It should be noted that in actuality there may be many more servo wedges than as shown in FIG. 1.

The disk 120 also includes a plurality of tracks on each disk surface. The plurality of tracks is depicted by two tracks, such as track 129 on the surface of the disk 120. The servo wedges 128 traverse the plurality of tracks, such as track 129, on the disk 120. The plurality of tracks, in some embodiments, may be arranged as a set of substantially concentric circles. Data is stored in fixed sectors along a track between the embedded servo wedges 128. The tracks on the disk 120 each include a plurality of data sectors. More specifically, a data sector is a portion of a track having a fixed block length and a fixed data storage capacity (e.g. 512 bytes of user data per data sector). The tracks toward the inside of the disk 120 are not as long as the tracks toward the periphery of the disk 110. As a result, the tracks toward the inside of the disk 120 can not hold as many data sectors as the tracks toward the periphery of the disk 120. Tracks that are capable of holding the same number of data sectors are grouped into a data zones. Since the density and data rates vary from data zone to data zone, the servo wedges 128 may interrupt and split up at least some of the data sectors. The servo wedges 128 are typically recorded with a servo writing apparatus at the factory (called a servo-writer), but may be written (or partially written) with the disk drive's 100 transducing head 146 in a self-servowriting operation.

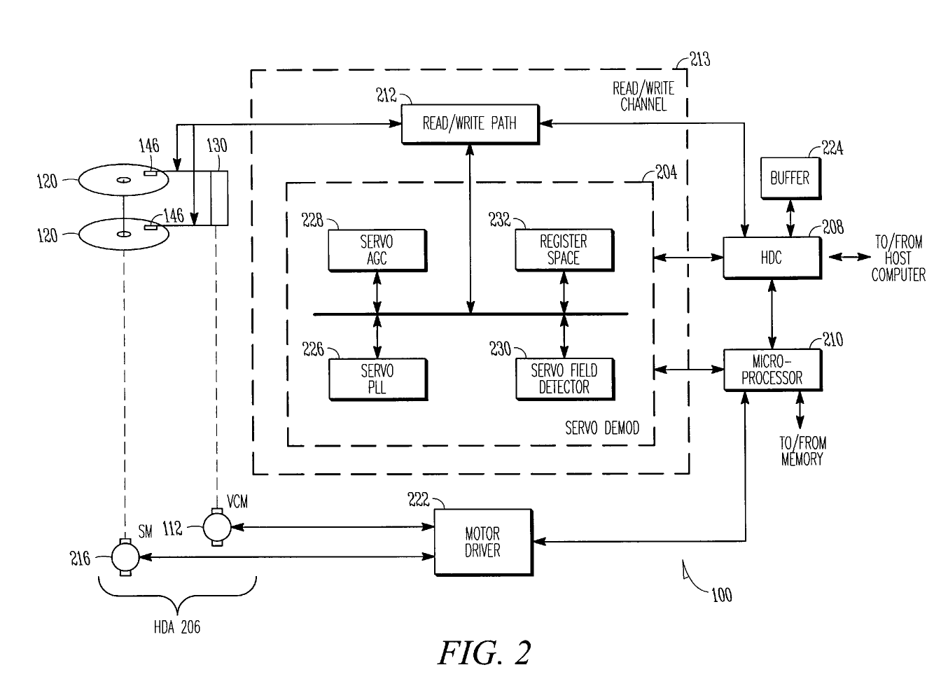

The disk drive 100 not only includes many mechanical features and a disk with a servo pattern thereon, but also includes various electronics for reading signals from the disk 120 and writing information representing data to the disk 120. FIG. 2 is a schematic diagram of a disk drive 100 that more fully details some of example electronic portions of the disk drive 100, according to an example embodiment. Referring to FIG. 2, the disk drive device 202 is shown as including a head disk assembly (HDA) 206, a hard disk controller (HDC) 208, a read/write channel 213, a microprocessor 210, a motor driver 222 and a buffer 224. The read/write channel 213 is shown as including a read/write path 212 and a servo demodulator 204. The read/write path 212, which can be used to read and write user data and servo data, may include front end circuitry useful for servo demodulation. The read/write path 212 may also be used for writing servo information in self-servowriting. It should be noted that the disk drive 100 also includes other components, which are not shown because they are not necessary to explain the example embodiments.

The HDA 206 includes one or more disks 120 upon which data and servo information can be written to, or read from, by transducers or transducing heads 146. The voice coil motor (VCM) 112 moves an actuator 130 to position the transducing heads 146 on the disks 10. The motor driver 222 drives the VCM 112 and the spindle motor (SM) 216. More specifically, the microprocessor 210, using the motor driver 222, controls the VCM 112 and the actuator 130 to accurately position the heads 146 over the tracks (described with reference to FIGS. 1-3) so that reliable reading and writing of data can be achieved. The servo fields 128, discussed above in the description of FIGS. 1-3, are used for servo control to keep the heads 146 on track and to assist with identifying proper locations on the disks 120 where data is written to or read from. When reading a servo wedge 128, the transducing heads 146 act as sensors that detect the position information in the servo wedges 128, to provide feedback for proper positioning of the transducing heads 146.

The servo demodulator 204 is shown as including a servo phase locked loop (PLL) 226, a servo automatic gain control (AGC) 228, a servo field detector 230 and register space 232. The servo PLL 226, in general, is a control loop that is used to provide frequency and phase control for the one or more timing or clock circuits (not shown in FIG. 2), within the servo demodulator 204. For example, the servo PLL 226 can provide timing signals to the read/write path 212. The servo AGC 228, which includes (or drives) a variable gain amplifier, is used to keep the output of the read/write path 212 at a substantially constant level when servo wedges 128 on one of the disks 120 are being read. The servo field detector 230 is used to detect and/or demodulate the various subfields of the servo wedges 128, including the SAM 204, the track number 206, the first phase servo burst 210, and the second phase servo burst 220. The microprocessor 210 is used to perform various servo demodulation functions (e.g., decisions, comparisons, characterization and the like), and can be thought of as being part of the servo demodulator 204. In the alternative, the servo demodulator 204 can have its own microprocessor.

One or more registers (e.g., in register space 232) can be used to store appropriate servo AGC values (e.g., gain values, filter coefficients, filter accumulation paths, etc.) for when the read/write path 212 is reading servo data, and one or more registers can be used to store appropriate values (e.g., gain values, filter coefficients, filter accumulation paths, etc.) for when the read/write path 212 is reading user data. A control signal can be used to select the appropriate registers according to the current mode of the read/write path 212. The servo AGC value(s) that are stored can be dynamically updated. For example, the stored servo AGC value(s) for use when the read/write path 212 is reading servo data can be updated each time an additional servo wedge 128 is read. In this manner, the servo AGC value(s) determined for a most recently read servo wedge 128 can be the starting servo AGC value(s) when the next servo wedge 128 is read.

The read/write path 212 includes the electronic circuits used in the process of writing and reading information to and from disks 120. The microprocessor 210 can perform servo control algorithms, and thus, may be referred to as a servo controller. Alternatively, a separate microprocessor or digital signal processor (not shown) can perform servo control functions.

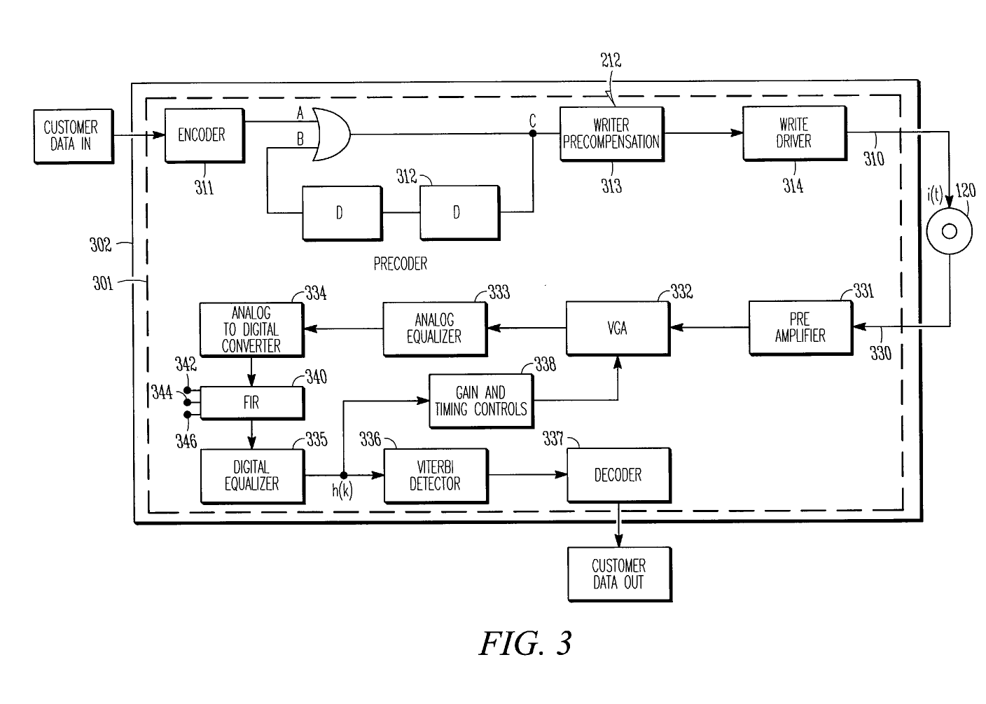

FIG. 3 is a schematic diagram of a read/write path 300 of the disk drive 100, according to an example embodiment. The read/write path 300 includes a write channel portion 310 and a read channel portion 330. The read/write path 300 is typically housed on a semiconductor chip, as depicted by the dotted line 301. The semiconductor chip is also placed on a printed circuit board 302, which is in turn attached to the housing 104 of the disk drive 100 (see FIG. 1). This is shown schematically in FIG. 3 so the size of the chip or semiconductor chip 301 relative to the printed circuit board 302 is out of scale. The read/write path 300 is typically contained in a semiconductor chip called a encoder/decoder (ENDEC). The read/write path 300 includes the write portion 310, which includes an encoder 311 and a precoder 312 for encoding the customer data, a write precompensation module 313, and a write driver 314. The write precompensation module 313 adjusts the signals associated with the encoded data so that, as written on the disk 120, the data will be more easily read using the read channel portion 330. The write driver 314 determines where the data will be written. In this particular embodiment, the data can either be written to a flush cache memory location 420 or to the disk 120 of the disk drive 100 (see FIG. 1). As will be discussed and described below, the flush cache memory location 420 can either be remote from the disk 120 or can be on the disk 120. The flush cache memory location 420 (shown in FIG. 3) is a schematic representation of the flush cache memory location and can include writing data to the disk 120 or to a memory location remote from the disk 120.

The read channel portion 330 of the read/write path includes a preamplifier 331, a variable gain amplifier 332, an analog equalizer 333, and an analog to digital converter 334. The elements 331 to 334 are used to amplify an analog signal, equalize it and convert it to a digital signal. After being converted by the analog to digital converter 334, the signal is then filtered by a finite impulse response (FIR) filter 340, and fed into a digital equalizer 335. Thereafter, the signal is then fed into a viterbi detector 336, and finally decoded by a decoder 337. The signal from the digital equalizer 335 is also fed to gain and timing controls 338, which are part of a feedback control loop to the variable gain amplifier 332. The FIR filter 340 includes various taps 342, 344, 346 that can be used to shape the signal from the digital equalizer or used to attenuate or substantially attenuate unwanted portions of a signal or attenuate an unwanted signal. It should be noted that FIG. 3 is one representative example of a read/write path 300. The invention is equally applicable to disk drive systems or magnetic recording systems that write transitions in the vertical orientation or write transitions in the horizontal orientation with respect to a major surface of the magnetic media, such as the disk of the disk drive.

FIG. 4 is an flow diagram of a method 400 for selecting a write current for a magnetic media, according to an example embodiment. The method 400 for selecting a write current for a magnetic media includes writing a test track on a magnetic media at one of a plurality of write current levels 410, and writing signals to the magnetic media at positions adjacent to the test track at substantially the same write current level as used on the test track 412. The method 400 also includes reading the signals from the magnetic media at positions adjacent to the test track 414, and monitoring a parameter associated with the signals read from the adjacent test track 416. The method 400 also includes repeating the writing, reading and monitoring while after writing to a test track at another one of the plurality of write current levels 418, and selecting one of the plurality of write current levels based on the parameter monitored for signals read from the adjacent track for each of the selected plurality of write currents 420. In one embodiment, the parameter associated with the signals read from positions adjacent the test track 414 is an error rate, and selecting one of the various write current levels 420 includes selecting the write current that produces a minimum error rate in the signals read from the adjacent the test track. The error rate is detected with an error correction code associated with a read channel of the disk drive. The various write current levels selected for writing a test track on a magnetic media 410 are write current levels that magnetically saturate the magnetic media. In one embodiment, writing to the test track 410 and writing the signals to the disk at positions adjacent to the test track 412 includes writing transitions vertically with respect to a major surface of the media. In another embodiment, the transitions written horizontally with respect to a major surface of the media. In one embodiment, the write current level for writing to the test track 410 and the write current level for writing the signals to the disk at positions adjacent to the test track 412 are substantially the same. The magnetic media, in one embodiment, is a disk 120 of a disk drive 100 (see FIG. 1). It should be noted that this method 400, or any of the methods discussed herein, can be applied to any device that uses a magnetic media and is not limited to a disk drive. Other examples of devices that include a magnetic media include a magnetic tape drive or a floppy disk drive, or the like.

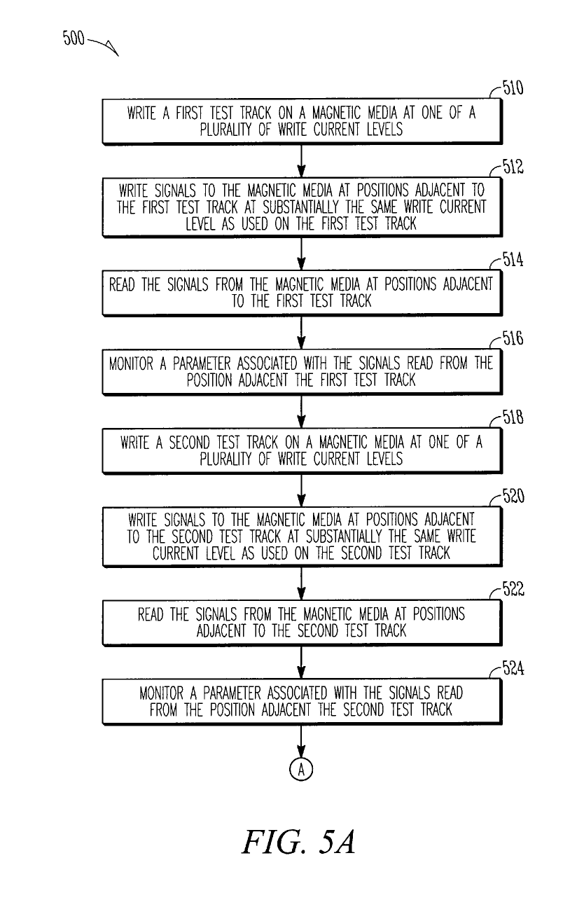

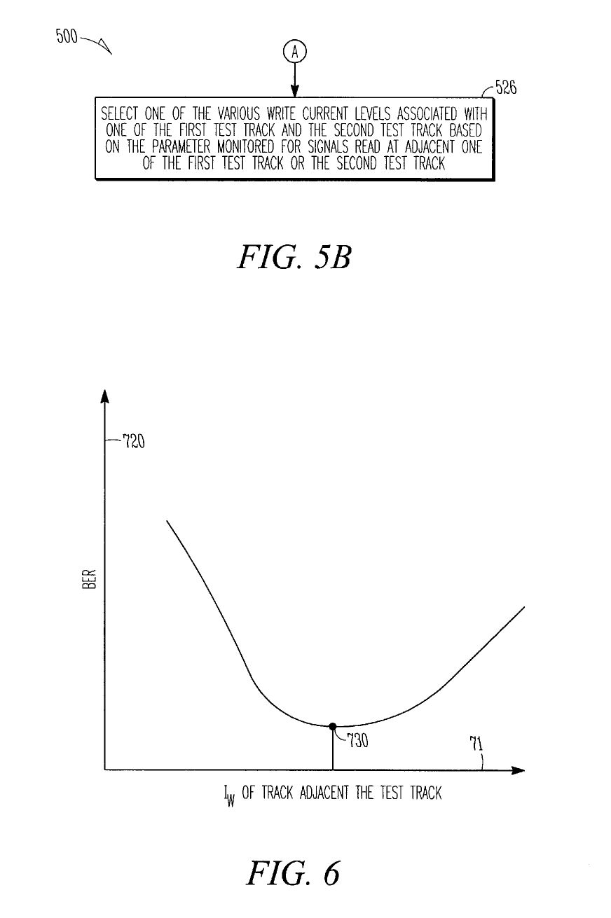

FIGS. 5A and 5B form FIG. 5. FIG. 5 is an flow diagram of a method 500 for selecting a write current for a magnetic medium, according to an example embodiment. The method 500 for selecting a write current for a magnetic storage device includes writing a first test track on a magnetic media at one of a plurality of write current levels 510, writing signals to the magnetic media at positions adjacent to the first test track at substantially the same write current level as used on the first test track 512, and reading the signals from the magnetic media at positions adjacent to the first test track 514. A parameter associated with the signals read from the position adjacent the first test track is monitored 516. The method 500 also includes writing a second test track on a magnetic media at one of a plurality of write current levels 518, writing signals to the magnetic media at positions adjacent to the second test track at substantially the same write current level as used on the second test track 520, and reading the signals from the magnetic media at positions adjacent to the second test track 522. A parameter associated with the signals read from the position adjacent the second test track is also monitored 524. One of the various write current levels associated with one of the first test track and the second test track is selected based on the parameter monitored for signals read at adjacent one of the first test track or the second test track 526. In one embodiment of the method 500, the first test track and the second test track are substantially the same track on the media associated with the magnetic storage device. In another embodiment of the method 500, the first test track and the second test track are different tracks on the media associated with the magnetic storage device. In one embodiment, the write head writes transitions in a vertical orientation with respect to a major surface of the magnetic media.

Using the methods of FIGS. 4 and 5, and plotting the results, the write current associated with a disk drive 100 (see FIG. 1) can be plotted verses a parameter for the track or tracks adjacent the test track indicative of the quality of the read back signal. One such parameter is the number of read errors. FIG. 6 is a graph 700 for selecting an optimum write current level for a magnetic medium in a disk drive, according to an example embodiment. The graph 700 is a plot of the write current (I_{w}) verses the bit error rate (BER) associated with a read of a track adjacent to the test track. The write current (I_{w}) is on the x-axis 71, and the bit error rate (BER) associated with a read of a track adjacent to the test track is on the y-axis 720. The write current (I_{w}) increases along the x-axis 71. The write current (I_{w}) at lower levels may not saturate the magnetic media and therefore the BER may be higher at these lower levels. As the write current (I_{w}) is increased a level is reached where the media is saturated. After the media is saturated, there is a point where the BER associated with a track adjacent to the test track is at a minimum 730. Increasing the write current beyond the minimum point 730 results in an increase in the BER in the track adjacent to the test track. At write currents beyond the minimum point 730, the write current on the test track affects the BER associated with reads from the track adjacent the test track. In other words, at a write current above the minimum point 730, the write current produces a bubble that is beyond the track and affects the adjacent track. At these write current (I_{w}) levels, writes to the adjacent track will also affect the BER associated with the test track. Therefore, the write current (I_{w}) level that produces a minimum BER in the adjacent tracks is an optimum level that will produce the least amount of errors in the magnetic media, such as a magnetic disk of a disk drive. Of course, the to the write current (I_{w}) level that produces a minimum BER may vary from disk drive to disk drive. In some disk drives, the write current (I_{w}) level that produces a minimum BER may vary from surface to surface on a disk within a disk drive. The minimum BER is based on the interaction of the write head with the magnetic media associated with the surface onto which the write head produces transitions. Even if the write heads are “identical” or made in an identical process, each one may be somewhat different in their writing characteristics. In addition, “identical” media made with identical processes may also vary. Thus, there may be different write currents (I_{w}) associated with different write transducers or write heads within a device, such as a disk drive. Therefore, in some embodiments of the invention the method for producing determining a minimum may be determined for each disk surface in a disk drive. In some embodiments, the different write current levels for each write transducer and disk surface may be determined during a self test after the disk drive is manufactured. In some embodiments, the instructions associated with the methods for selecting a write current (I_{w}) are stored in the microprocessor 210 associated with the disk drive 100. The result is stored in memory associated with the disk drive. Memory is also used to store the instruction sets associated with the various methods, such as method 400, 500 and 700.

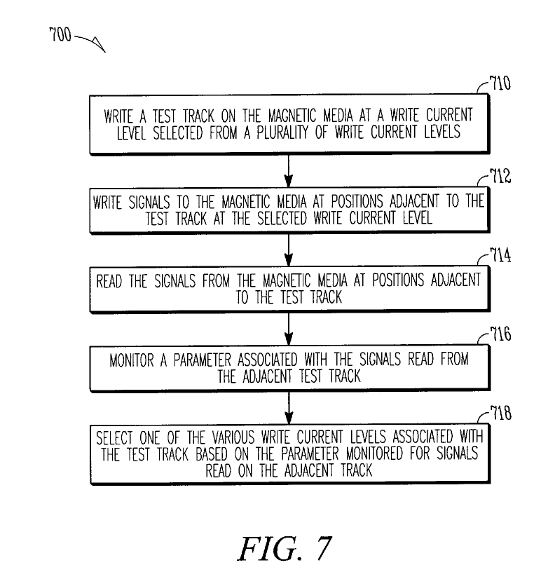

FIG. 7 is an flow diagram of yet another method 700 for selecting a write current for a magnetic media, according to an example embodiment. As mentioned above, a disk drive includes a write head, a read head, and a channel for reading and writing information from and to a magnetic media. The channel including an error detection and correction apparatus. The disk drive also includes a microcontroller for controlling portions of the disk drive. The microcontroller is capable of executing instructions that include the method 700 for selecting the write current for a magnetic media associated with the disk drive. More specifically, the microcontroller is capable of executing instructions that include writing a test track on the magnetic media at a write current level selected from a plurality of write current levels 710, writing signals to the magnetic media at positions adjacent to the test track at the selected write current level 712, reading the signals from the magnetic media at positions adjacent to the test track 714, and monitoring a parameter associated with the signals read from the adjacent test track 716. The microcontroller also executes instructions that select one of the various write current levels associated with the test track based on the parameter monitored for signals read on the adjacent track 718. The disk drive, in one example embodiment, monitors an error rate with the error detection and correction apparatus, and uses a memory for accumulating a number of errors or an error rate. The write head writes transitions in a vertical orientation with respect to a major surface of the magnetic media, and the read head reads transitions having the vertical orientation. In another embodiment, the write head writes transitions in a horizontal orientation with respect to a major surface of the magnetic media.

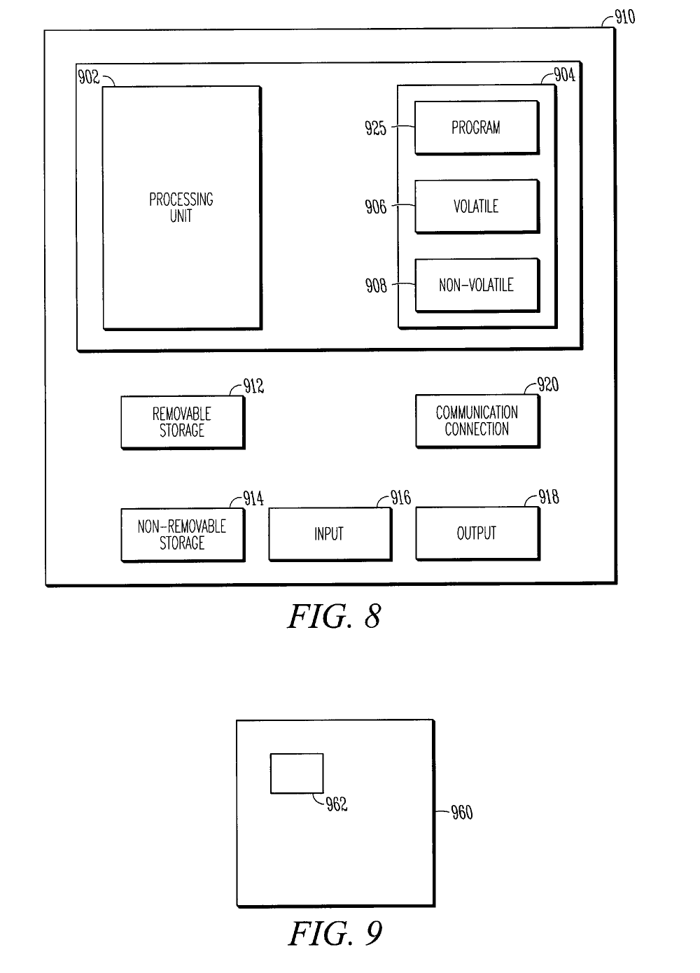

A block diagram of a computer system that executes programming for performing the above algorithm is shown in FIG. 8. A general computing device in the form of a computer 910, may include a processing unit 902, memory 904, removable storage 912, and non-removable storage 914. Memory 904 may include volatile memory 906 and non volatile memory 908. Computer 910 may include any type of information handling system in any type of computing environment that includes any type of computer-readable media, such as volatile memory 906 and non volatile memory 908, removable storage 912 and non-removable storage 914. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 910 may include or have access to a computing environment that includes input 916, output 918, and a communication connection 920. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks. A microprocessor or controller associated with the disk drive 100 (see FIG. 1) is also such a computer system.

Computer-readable instructions stored on a machine-readable medium are executable by the processing unit 902 of the computer 910. A hard drive, CD-ROM, and RAM are some examples of articles including a machine-readable medium. For example, a computer program 925 executed to control the writing of information associated with successive flush cache commands from a host 440 according to the teachings of the present invention may be included on a CD-ROM and loaded from the CD-ROM to a hard drive. The computer program may also be termed firmware associated with the disk drive 100. In some embodiments, a copy of the computer program 925 can also be stored on the disk 120 of the disk drive 100.

FIG. 9 is a schematic diagram that shows a machine readable medium 960 and an instruction set 962 associated with the machine readable medium 960, according to an example embodiment. The machine-readable medium 960 provides instructions 962 that, when executed by a machine, such as a computer, cause the machine to perform operations including writing a test track on a magnetic media at a various selected write current levels, writing signals to the magnetic media at positions adjacent to the test track at a substantially fixed selected write current level, and reading the signals from the magnetic media at positions adjacent to the test track. A parameter associated with the signals read from the adjacent test track is monitored. The instructions cause the machine, such as a computer or microcontroller, to select one of the various write current levels associated with the test track based on the parameter monitored for signals read on the adjacent track. The machine-readable medium provides instructions that, when executed by a machine, monitor an error rate when monitoring a parameter associated with the signals read to the adjacent test track. The instructions further cause the machine to perform operations that further include storing an error rate associated with reading signals from a location adjacent a test track written at a first write level current, storing an error rate associated with reading signals from a location adjacent a test track written at a second write level current. Selecting one of the various write current levels includes selecting the one of the first write current level or second write current level having the lower error rate associated therewith.

The foregoing description of the specific embodiments reveals the general nature of the invention sufficiently that others can, by applying current knowledge, readily modify and/or adapt it for various applications without departing from the generic concept, and therefore such adaptations and modifications are intended to be comprehended within the meaning and range of equivalents of the disclosed embodiments.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A method for selecting a write current for a disk drive, the method comprising:
writing a test track on a magnetic media at one of a plurality of write current levels;
writing signals to the magnetic media at positions adjacent to the test track at substantially the same write current level as used on the test track;
reading the signals from the magnetic media at positions adjacent to the test track;
monitoring a parameter associated with the signals read from the adjacent test track;
repeating the writing, reading and monitoring while after writing to a test track at another one of the plurality of write current levels; and
selecting one of the plurality of write current levels based on the parameter monitored for signals read from the adjacent track for each of the selected plurality of write currents.

2. The method of claim 1 wherein the parameter associated with the signals read from positions adjacent the test track is an error rate.

3. The method of claim 2 wherein selecting one of the various write current levels includes selecting the write current that produces a minimum error rate in the signals read from the adjacent the test track.

4. The method of claim 2 wherein the error rate is detected with an error correction code associated with a read channel of the disk drive.

5. The method of claim 1 wherein the various write current levels selected for writing a test track on a magnetic media are write current levels that magnetically saturate the magnetic media.

6. The method of claim 1 wherein writing to the test track and writing the signals to the disk at positions adjacent to the test track are written vertically with respect to a major surface of the media.

7. The method of claim 1 wherein writing to the test track and writing the signals to the disk at positions adjacent to the test track are written horizontally with respect to a major surface of the media.

8. The method of claim 1 wherein the write current level for writing to the test track and the write current level for writing the signals to the disk at positions adjacent to the test track are substantially the same.

9. The method of claim 1 wherein the magnetic media is a disk of a disk drive.

10. A disk drive comprising:
a write head;
a read head;
a channel for reading and writing information from and to a magnetic media, the channel including an error detection and correction apparatus; and
a microcontroller for controlling portions of the disk drive, the microcontroller executing instructions further comprising:
writing a test track on the magnetic media at a write current level selected from a plurality of write current levels;
writing signals to the magnetic media at positions adjacent to the test track at the selected write current level;
reading the signals from the magnetic media at positions adjacent to the test track;
monitoring a parameter associated with the signals read from the adjacent test track; and
selecting one of the various write current levels associated with the test track based on the parameter monitored for signals read on the adjacent track.

11. The disk drive of claim 10 wherein monitoring the parameter includes monitoring an error rate with the error detection and correction apparatus.

12. The disk drive of claim 10 wherein the error detection and correction apparatus includes a memory for accumulating a number of errors.

13. The disk drive of claim 10 wherein the write head writes transitions in a vertical orientation with respect to a major surface of the magnetic media.

14. The disk drive of claim 10 wherein the read head reads transitions having a vertical orientation with respect to a major surface of the magnetic media.

15. The disk drive of claim 10 wherein the write head writes transitions in a horizontal orientation with respect to a major surface of the magnetic media.

16. A machine-readable medium that provides instructions that, when executed by a machine, cause the machine to perform operations comprising:
writing a test track on a magnetic media at a various selected write current levels;
writing signals to the magnetic media at positions adjacent to the test track at a substantially fixed selected write current level;
reading the signals from the magnetic media at positions adjacent to the test track;
monitoring a parameter associated with the signals read from the adjacent test track; and
selecting one of the various write current levels associated with the test track based on the parameter monitored for signals read on the adjacent track.

17. The machine-readable medium of claim 16 that provides instructions that, when executed by a machine, monitor an error rate when monitoring a parameter associated with the signals read to the adjacent test track.

18. The machine-readable medium of claim 17 that provides instructions that, when executed by a machine, further cause the machine to perform operations that further comprise:
storing an error rate associated with reading signals from a location adjacent a test track written at a first write level current;
storing an error rate associated with reading signals from a location adjacent a test track written at a second write level current; and
wherein selecting one of the various write current levels includes selecting the one of the first write current level or second write current level having the lower error rate associated therewith.

19. A method for selecting a write current for a magnetic storage device, the method comprising:
writing a first test track on a magnetic media at one of a plurality of write current levels;
writing signals to the magnetic media at positions adjacent to the first test track at substantially the same write current level as used on the first test track;
reading the signals from the magnetic media at positions adjacent to the first test track;
monitoring a parameter associated with the signals read from the position adjacent the first test track;
writing a second test track on a magnetic media at one of a plurality of write current levels;
writing signals to the magnetic media at positions adjacent to the second test track at substantially the same write current level as used on the second test track;
reading the signals from the magnetic media at positions adjacent to the second test track;
monitoring a parameter associated with the signals read from the position adjacent the second test track; and
selecting one of the various write current levels associated with one of the first test track and the second test track based on the parameter monitored for signals read at adjacent one of the first test track or the second test track.

20. The method of claim 19 wherein the first test track and the second test track are substantially the same track on the media associated with the magnetic storage device.

21. The method of claim 19 wherein the first test track and the second test track are different tracks on the media associated with the magnetic storage device.

22. The method of claim 10 wherein the write head writes transitions in a vertical orientation with respect to a major surface of the magnetic media.
